(19) United States
(12) Patent Application Publication
(10) Pub. No.: US 2004/0075348 A1
(43) Pub. Date: Apr. 22, 2004

(54) Method for field programmable radio frequency identification devices to perform switching functions

(75) Inventors: Andrei Obrea, Seymour, CT (US); Brian M. Romansky, Monroe, CT (US); Thomas J. Foth, Trumbull, CT (US); Jeffrey D. Pierce, Sandy Hook, CT (US); Anand V. Chhatpar, Madison, WI (US)

Correspondence Address: Pitney Bowes Inc., Intellectual Property and Technology Law Dept., 35 Waterview Drive, P.O. Box 3000, Shelton, CT, 06484, US

(73) Assignee: Pitney Bowes Incorporated, Stamford, CT

(21) Appl. No.: 10/430,922

(22) Filed: May 7, 2003

Related U.S. Application Data
(60) Provisional application No. 60/419,361, filed on Oct. 18, 2002.

(51) Int. Cl. H01H 47/00; H01H 83/00

(52) U.S. Cl. 307/125

(57) ABSTRACT

A method that allows a circuit attached to a material, i.e., paper, to be controlled by performing a switching function by drawing lines on the paper with a pencil. The drawn connections may be changed by erasing the drawn connections with a pencil eraser and writing new connections on the paper with a pencil. Connections may also be drawn into a circuit or have the drawn connections cause the circuit to perform some function by utilizing a standard ink jet printer or laser printer to print lines on paper equipped with a circuit, by having the printed lines perform the function of wires.

This Application claims the benefit of the filing date of U.S. Provisional Application Number 60/419,361 filed Oct. 18, 2002, which is owned by the assignee of the present Application.

### CROSS REFERENCE TO RELATED APPLICATIONS

Reference is made to commonly assigned co-pending patent applications Docket No. F-632 filed herewith entitled “METHOD FOR FIELD PROGRAMMABLE RADIO FREQUENCY DOCUMENT IDENTIFICATION DEVICES” in the names of Anand V. Chhatpar, Jeffrey D. Pierce, Brian M. Romansky, Thomas J. Foth, and Andrei Obrea; Docket No. F-633 filed herewith entitled “METHOD FOR FIELD PROGRAMMING RADIO FREQUENCY IDENTIFICATION DEVICES THAT CONTROL REMOTE CONTROL DEVICES” in the names of Jeffrey D. Pierce, Brian M. Romansky, Thomas J. Foth, and Anand V. Chhatpar; Docket No. F-635 filed herewith entitled “METHOD FOR FIELD PROGRAMMABLE RADIO FREQUENCY IDENTIFICATION TESTING DEVICES FOR TRANSMITTING USER SELECTED DATA” in the names of Thomas J. Foth, Brian M. Romansky, Jeffrey D. Pierce, Andrei Obrea, and Anand V. Chhatpar; Docket No. F-638 filed herewith entitled “METHOD FOR FIELD PROGRAMMING RADIO FREQUENCY IDENTIFICATION LABELS” in the names of Thomas J. Foth, Brian M. Romansky, Jeffrey D. Pierce, and Anand V. Chhatpar; Docket No. F-639 filed herewith entitled “METHOD FOR FIELD PROGRAMMING RADIO FREQUENCY IDENTIFICATION RETURN FORMS” in the names of Jeffrey D. Pierce, Thomas J. Foth, Brian M. Romansky, Andrei Obrea, and Anand V. Chhatpar; and F-640 filed herewith entitled “METHOD AND APPARATUS FOR FIELD PROGRAMMING RADIO FREQUENCY IDENTIFICATION DEVICES” in the names of Brian M. Romansky, Thomas J. Foth, Jeffrey D. Pierce, Andrei Obrea and Anand V. Chhatpar.

### FIELD OF THE INVENTION

This invention pertains to electronic circuits and, more particularly, to printing electrical conductive traces on materials to perform switching functions.

### BACKGROUND OF THE INVENTION

Physically, switching circuits consists of conducting paths interconnecting discrete-valued electrical devices. The most generally used switching circuit devices are two-valued or binary, in which manual or electromagnetic actuation opens and closes electric contacts. The binary conditions are open path and closed path. Such two-valued electrical conditions, as applied to the input of a switching circuit, represent either a combination of events or situations which exist or do not exist; or a sequence of events or situations which occur in a certain order; or both combinations and sequences of events or situations. The switching circuit responds to such inputs by delivering at its output, also in two-valued terms, new information, which is functionally related to the input information. Multiple pole switching circuits in which various lines or inputs may be selected have also been utilized by the prior art.

Prior art switching circuits had mechanical which made the switching circuits expensive to manufacture.

The user controlled switching devices utilized in the prior art were single poled or multiple poled devices or dials in which the user physically moved a throwing mechanism or dial to use the switch. As the prior art reduced the size of switches in order to consume less space, the switches became smaller and more difficult to use.

In particular when there are a large number of switches it is difficult to reliably reconfigure a different switching pattern from written instructions.

A typical business card has a persons name, title, business affiliation, business mailing address, telephone number, facsimile number and e-mail address. Business cards are exchanged between people who work for the same organization or other organizations so that they may contact each other at a later time. Business cards that one receives may be kept in a file for future reference and/or the information on the card may be copied into a book and/or card. When someone wants to contact the person listed on a business card, they find the business card and dial the telephone number or facsimile number listed on the card. Local telephone numbers usually have seven digits and long distance telephone numbers usually have eleven digits. International telephone numbers may have thirteen digits. Frequently, incorrect telephone numbers and/or facsimile numbers are dialed. The foregoing may result in a sensitive facsimile being sent to an incorrect party. Also, time consuming and annoying telephone calls may be made.

### SUMMARY OF THE INVENTION

This invention overcomes the disadvantages of the prior art by providing a method that allows a circuit to be controlled by performing a switching function by drawing lines on a material with a pencil, ballpoint pen or conductive ink. The material may be any cellulose type product, i.e., paper, cardboard, chipboard, wood or plastic, fabric, animal hide, etc. The drawn connection may be changed by erasing the drawn connection with a pencil eraser or a ink eraser and writing new connections on the material with a pencil or ballpoint pen. The connections may also be drawn by a standard ink jet or laser printer, to print lines on the material, by having the printed lines perform the function of wires.

This invention utilizes a circuit by exposing on a material switch contacts to be left open or closed. A user may complete the circuit by filling in the space between the connections with a pencil or ballpoint pen. Alternatively, the circuit may expose switch contacts on a material with all of the connections made, and a user may break a space between the connections with a sharp instrument or hole punch.

An additional advantage of this invention is that this invention provides a switching circuit that requires little space and is easy to use.

A further advantage of this invention is that this invention provides a plurality of switches that are used to program a device.

A further advantage of this invention is that the switching pattern made on the material becomes the actual switch bypassing the need for a human to physically reconfigure the switches. The material with the switching pattern on it also becomes an archival record of the switching configuration.

An additional advantage of this invention is that the switching pattern that was made on the material may be photocopied and thus reliably reproducing the switching configuration for a plurality of uses.

An additional advantage of this invention is that a business card may be placed in a control circuit so that the holder of the business card may automatically dial telephone numbers and/or facsimile numbers.

### BRIEF DESCRIPTION OF THE DRAWINGS

FIG. 1 is a block diagram of a prior art RFID circuit;

FIG. 2A is a drawing of a circuit 24 that replaces memory array 21 of FIG. 1 showing how programming of the bits may be accomplished by making the bits externally available for programming RFID circuit 10;

FIG. 2B is a drawing of a circuit 300 that is an alternate representation of circuit 24, that replaces memory array 21 of FIG. 1 showing how programming of the bits may be accomplished by making the bits externally available for programming RFID circuit 10;

FIG. 3 is a drawing showing sensor circuit 25 of FIG. 2A in greater detail;

FIG. 4 is a seller furnished form to be completed by a buyer returning goods to a seller;

FIG. 5 is a drawing showing how a modified RFID circuit, attached to a piece of paper may be controlled by performing a switching function with a pencil;

FIG. 6 is a drawing showing how a printed circuit, printed on a piece of paper, may be controlled by performing a switching function by drawing lines with a pencil;

FIG. 7 is a drawing showing how a modified RFID circuit attached to a piece of paper may be altered to indicate a desired selection;

FIG. 8 is a drawing showing how a printed circuit card may be controlled by drawing lines with a pencil that connect various components of the printed circuit card;

FIG. 9 is a drawing of a front view of circuit control device 200;

FIG. 10 is a drawing of a side view of a card inserted in circuit control device 200; and

FIG. 11 is a drawing of the back of a business card showing how the back of a business card may permit a user to program their telephone number.

### DETAILED DESCRIPTION OF THE PREFERRED EMBODIMENT

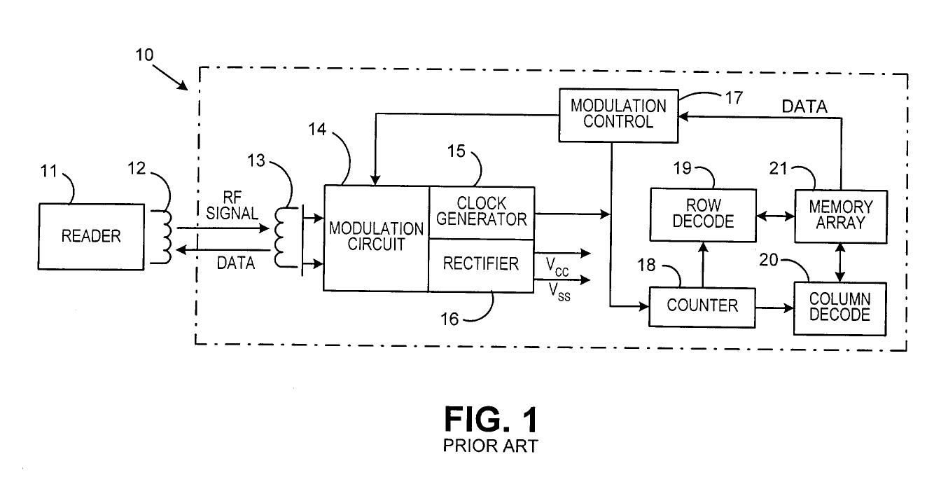

Referring now to the drawings in detail, and more particularly to FIG. 1, the reference character 10 represents a prior art RFID circuit. Circuit 10 may be the model MCRF 200 manufactured by Microchip Technology, Inc. of 2355 West Chandler Blvd, Chandler, Ariz. 85224. RFID reader 11 is connected to coil 12, and 12 is coupled to coil 13. Coil 13 is connected to modulation circuit 14. Modulation circuit 14 is connected to clock generator 15 and rectifier 16. Modulation control 17 is coupled to modulation circuit 14, clock generator 15 and counter 18. Counter 18 is coupled to column decode 20. Row decode 19 is coupled to memory array 21, and array 21 is coupled to modulation control 17. It would be obvious to one skilled in the art that a battery may be used to supply power to circuit 10.

Reader 11 has a transmitter mode and a receiver mode. During the transmit mode of reader 11, reader 11 transmits a radio frequency signal for a burst of time via coil 12. After the transmission of a signal by reader 11, reader 11 turns into a receiver. Coil 12 is inductively linked with coil 13, and coil 13 receives the radio frequency signal from coil 12 and converts the aforementioned signal into inductive energy, i.e., electricity. When coil 13 has sufficient energy, coil 13 will cause clock generator 15 to generate timing pulses which drive counter 18. Counter 18 drives row decode 19 which causes memory array 21 to read the fixed bit data pattern stored in memory array 21 one bit at a time. As the data bits are being read by array 21, the data bits are transmitted to modulation control circuit 17. Control circuit 17 sends the data bits to reader 11 via modulation circuit 14 and coils 13 and 12.

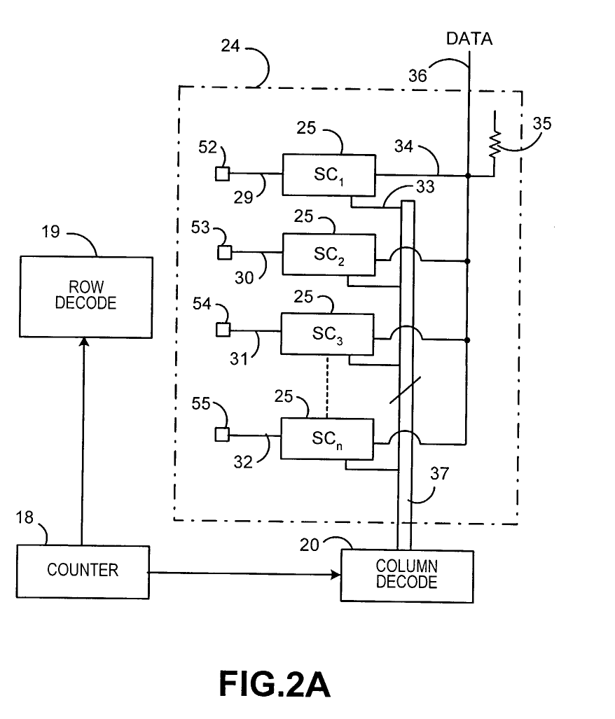

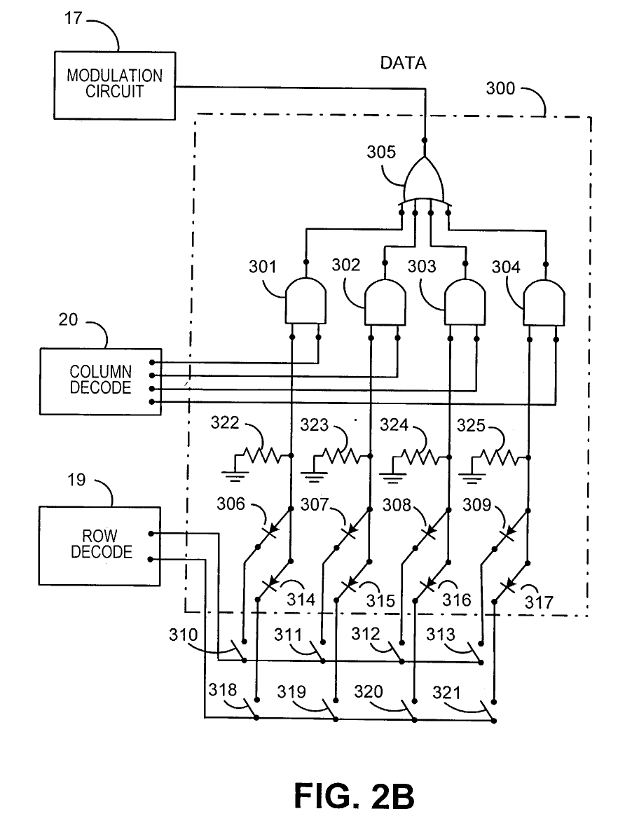

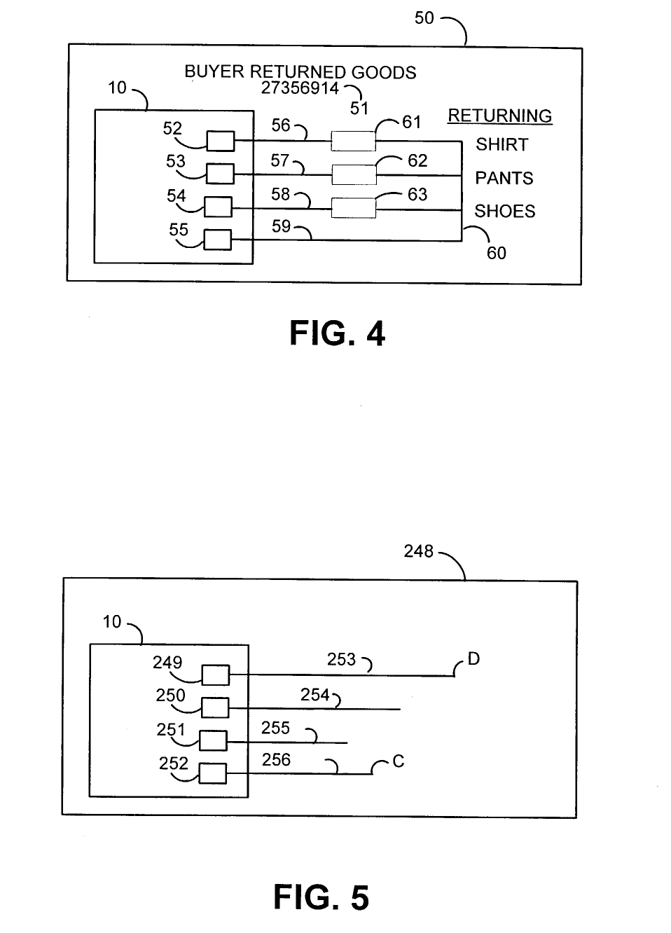

FIG. 2A is a drawing of a circuit 24 that replaces memory array 21 of FIG. 1 showing how programming of the bits may be accomplished by making the bits externally available for programming RFID circuit 10. A plurality of sensor circuits 25 is contained in circuit 24. Sensor circuits 25 are labeled SC₁ SC₂ SC₃ . . . SCₙ Line 29 is connected to SC₁ and graphite contact 52 and line 30 is connected to SC₂ and graphite contact 53. Line 31 is connected to SC₃ and graphite contact 54 and line 32 are connected to SCₙ and graphite contact 55. There is a sensor circuit 25 for each graphite contact. The description of FIG. 4 will describe how information may be entered into circuit 24 via graphite contacts 52-55. SC₁ has an input 33, which enables the data output 34. Input 33 is connected to one of the n lines 37, and data output 34 is connected to data line 36 and pull up resistor 35. Data line 36 is connected to modulation control 17 (FIG. 1).

When counter 18 selects the value 1, column decode 20 will enable line 33, which will cause the same logic level that is on graphite contact 52 to be placed on data output 34. When line 33 is not selected, the value on graphite contact 52 does not have any influence on the data output line 34. Enable outputs 33 for SC₁ . . . SCₙ are bundled together in lines 37 so that only one line 37 is turned on at a time. Lines 37 are connected to column decode 20. Column decode 20 is connected to counter 18, and counter 18 is connected to row decode 19. Counter 18 generates a sequence of numbers from 1 through n to enable a different line 37 in sequential order. Thus, data line 36 will receive the data outputs 34 from SC₁ . . . SCₙ at different times.

FIG. 2B is a drawing of a circuit 300 that is an alternate representation of circuit 24, that replaces memory array 21 of FIG. 1 showing how programming of the bits may be accomplished by making the bits externally available for programming RFID circuit 10. Circuit 300 includes AND gates 301, 302, 303 and 304 and OR gate 305.

One of the inputs of AND gate 301 is connected to column decode 20 and the other input to AND gate 301 is connected to one of the ends of resistor 322, one of the ends of diode 306 and one of the ends of diode 314. The other end of resistor 322 is connected to ground. The other end of diode 306 is connected to one of the terminals of toggle switch 310, and the other end of toggle switch 310 is connected to row decode 19. The other end of diode 314 is connected to one of the terminals of toggle switch 318, and the other end of toggle switch 318 is connected to row decode 19.

One of the inputs of AND gate 302 is connected to column decode 20, and the other input to AND gate 302 is connected to one of the ends of resistor 323, one of the ends of diode 307 and one of the ends of diode 315. The other end of resistor 323 is connected to ground. The other end of diode 307 is connected to one of the terminals of toggle switch 311, and the other end of toggle switch 311 is connected to row decode 19. The other end of diode 315 is connected to one of the terminals of toggle switch 319, and the other end of toggle switch 319 is connected to row decode 19.

One of the inputs of AND gate 303 is connected to column decode 20, and the other input to AND gate 303 is connected to one of the ends of resistor 324, one of the ends of diode 308 and one of the ends of diode 316. The other end of resistor 324 is connected to ground. The other end of diode 308 is connected to one of the terminals of toggle switch 312, and the other end of toggle switch 312 is connected to row decode 19. The other end of diode 316 is connected to one of the terminals of toggle switch 320, and the other end of toggle switch 320 is connected to row decode 19.

One of the inputs of AND gate 304 is connected to column decode 20, and the other input to AND gate 304 is connected to one of the ends of resistor 325, one of the ends of diode 309 and one of the ends of diode 317. The other end of resistor 325 is connected to ground. The other end of diode 309 is connected to one of the terminals of toggle switch 313, and the other end of toggle switch 312 is connected to row decode 19. The other end of diode 317 is connected to one of the terminals of toggle switch 321, and the other end of toggle switch 321 is connected to row decode 19.

Column decode 20 and row decode 19 function by taking the selected output at logic one, i.e., a high level and keeping all the other outputs at logic zero, i.e., a low level. The output of AND gates 301-304 are connected to the input of OR gate 305, and the output of OR gate 305 is data that is connected to the input of modulation circuit 17. If switches 310, 311, 312 and 313, respectively, remain open, AND gates 301-304, respectively, will have a “zero” output. If switches 310, 311, 312 and 313, respectively, are closed, AND gates 301-304, respectively, will have a “one” output. The output of AND gates 301-304, respectively, will be read when switches 318-321, respectively, are closed.

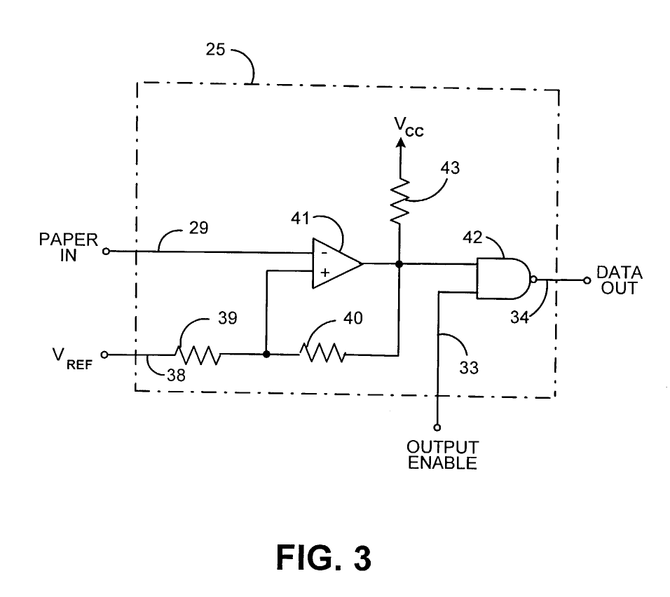

FIG. 3 is a drawing showing sensor circuit 25 of FIG. 2A in greater detail. The negative input of comparator 41 is connected to line 29, and the positive input of comparator 41 is connected to line 38. Comparator 41 may be a LM339N comparator. One end of line 38 is connected to a 2-3 volt reference voltage, and the other end of line 38 is connected to one of the ends of resistor 39. The other end of resistor 39 is connected to the positive input of comparator 41 and one of the ends of resistor 40. The other end of resistor 40 is connected to the input of NAND gate 42, the output of comparator 41 and one of the ends of resistor 43. The other end of resistor 43 is connected to a source voltage to act as a pull up resistor. The other input to NAND gate 42 is enable output 33. The output of gate 42 is data output 34. Resistor 39 may be 47,000 ohms, and resistor 40 may be 470,000 ohms. Resistor 43 may be 1,000 ohms. Comparator 41 has a positive feedback to provide a small amount of hysteresis

Sensor circuit 25 is a differential circuit that accommodates variations in the conductivity of the conductive material. The conductive material may be used as a voltage divider to produce V_{ref} on line 38 under the same conditions experienced by paper in on line 29. Thereby, nullifying the effects of varying resistance in the conductive material. It will be obvious to one skilled in the art that sensor circuit 25 may replace switches 310-313 and 318-321 of FIG. 2B.

FIG. 4 is a seller-furnished form to be completed by a buyer returning goods to a seller. RFID circuit 10 is attached to paper 50 by means of a conductive adhesive such as an anisotropic adhesive (not shown). The seller places a returned goods identification number 51 on the form to identify the buyer by writing the invoice number for the purchased goods on paper 50 in a manner that number 51 may be read by a RFID reader. Graphite contacts 52, 53, 54 and 55 and lines 56, 57, 58, 59 and 60 are printed on standard bond paper, standard photocopier paper, standard computer paper, etc., by a standard computer printer like the model Desk Jet 880C printer manufactured by Hewlett Packard using a Hewlett Packard 45 black ink cartridge.

If the buyer decides to return a shirt to the seller, the buyer uses a graphite pencil, i.e., number 2, HB, etc., or a Paper Mate® black ballpoint pen to fill in rectangle 61. If the buyer decides to return pants to the seller, the buyer fills in rectangle 62 with a graphite pencil, and if the buyer decides to return shoes to the seller, the buyer fills in rectangle 63 with a graphite pencil. If the buyer changes his/her mind regarding the goods to be returned or makes a mistake in filling in one of the rectangles, the buyer could erase the penciled marking in the rectangle with a pencil eraser so that a RFID reader would only read what the buyer indicated on the finished form. The buyer would insert the finished form into a package (not shown) containing the returned goods, and the seller would be able to read the completed form when he/she receives the package with a RFID read without opening the package.

FIG. 5 is a drawing showing how a modified RFID circuit, attached to a piece of paper, may be controlled by performing a switching function by drawing lines with a pencil. RFID circuit 10 is attached to paper 248 by means of an adhesive (not shown). Graphite contacts 249, 250, 251 and 252 and lines 253, 254, 255, 256 and 257 are printed on paper 248 by a standard computer printer like the model Desk Jet 880C printer, that is manufactured by Hewlett Packard using a Hewlett Packard 45 black ink cartridge. If a human user wanted to select the information represented by line 253, the user would draw a penciled line (not shown) between points C and D without touching lines 254 and 255.

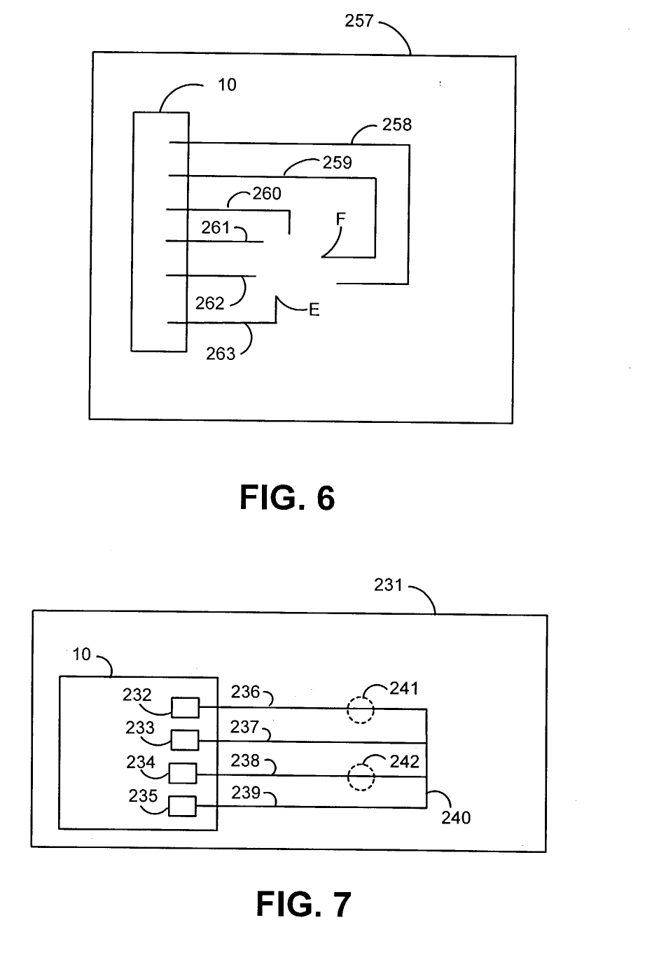

FIG. 6 is a drawing showing how a printed circuit, printed on a piece of paper, may be controlled by performing a switching function by drawing lines with a pencil. Lines 258, 259, 260, 261, 262 and 263 are printed on paper 257 by a standard computer printer like the model Desk Jet 880C printer, that is manufactured by Hewlett Packard using a Hewlett Packard 45 black ink cartridge or Hewlett Packard laser printer. If a human user wanted to select the information represented by line 259, the user would draw a penciled line (not shown) between points E and F without touching lines 258, 260, 261, and 262. Lines 258-263 are connected to circuit 10. It would be obvious to one skilled in the art that any circuit to be controlled externally by switching may be substituted for RFID circuit 10. After someone drew a line between points E and F a photocopy may be made of FIG. 6 and RFID circuit 10 may be attached to the photocopy of FIG. 6 by means of a adhesive. Since the fused toner of the photocopy machine is conductive the photocopied lines in FIG. 6 become equivalent wires.

FIG. 7 is a drawing showing how a modified RFID circuit attached to a piece of paper may be altered to indicate a desired selection. RFID circuit 10 is attached to paper 231 by means of an adhesive (not shown). Graphite contacts 232, 233, 234 and 235 and lines 236, 237, 238 and 239 are printed on paper 231 by a standard computer printer like the model Desk Jet 880C printer manufactured by Hewlett Packard using a Hewlett Packard 45 black ink cartridge. If a human user wanted to alter the information represented by line 236 or 238, the user would remove adhesive labels 241 or 242 on lines 236 or 238. A RFID reader (not shown) will be able to read the above selection.

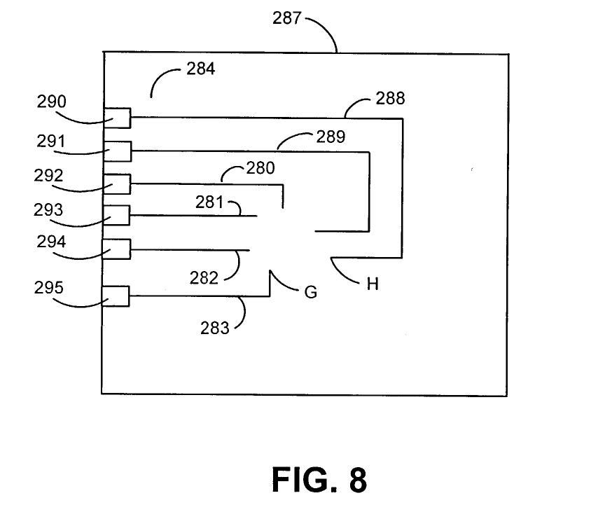

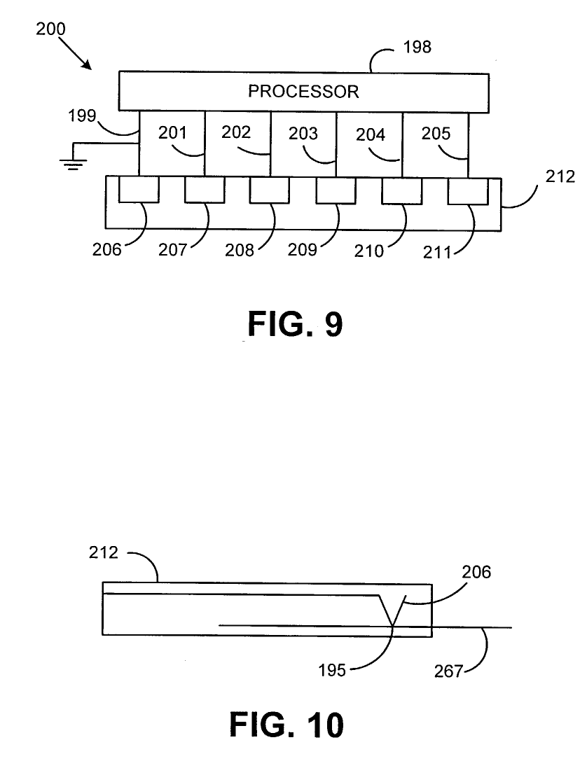

FIG. 8 is a drawing showing how a printed circuit, may be controlled by performing a switching function with a pencil. A standard computer printer, like the model Desk Jet 880C printer that is manufactured by Hewlett Packard using a Hewlett Packard 45 black ink cartridge or Hewlett Packard laser printer, prints lines 288, 289, 280, 281, 282 and 283 on card 287. Electrical contacts 290, 291, 292, 293, 294 and 295 are attached to card 287. Line 288 forms an electrical connection with contact 290 and line 289 forms an electrical connection with contact 291. Line 280 forms an electrical connection with contact 292, and line 281 forms an electrical connection with contact 293. Line 282 forms an electrical connection with contact 294, and line 283 forms an electrical connection with contact 295. If a human user wanted to select the information represented by line 288, the user would draw a penciled line (not shown) between points G and H without touching lines 288, 289, 280, 281, and 282. Card 287 may be inserted into control circuit 200 of FIG. 9. Circuit control device 200 may be any microprocessor device that needs to be controlled externally.

FIG. 9 is a drawing of a front view of circuit control device 200. Copper spring contacts 206, 207, 208, 209, 210 and 211 are spaced in housing 212 of device 200 in a manner that, when card 167 (FIG. 6) is inserted into device 200, electrical contacts 290, 291, 292, 293, 294 and 295, respectively, will be engaged with copper spring contacts 211, 210, 209, 208, 207 and 206. Copper spring contact 206 is connected to ground and to processor 198 by wire 199, and copper spring contact 207 is connected to processor 198 via wire 201. Embedded in processor 198 is a plurality of sensor circuits 25 (not shown here and described in FIG. 3) such that paper in on line 29 is connected to each of lines 201, 202, 203, 204 and 205. Data output line 34 of sensor circuit 25 is connected to the input ports (not shown) internal to processor 198. Copper spring contact 208 is connected to processor 198 by wire 202, and copper spring contact 209 is connected to processor 198 via wire 203. Copper spring contact 210 is connected to processor 198 by wire 204, and copper spring contact 211 is connected to processor 198 via wire 205. Device 200 and card 267 may be used to set and/or control many different types of electrical and/or electronic devices, i.e., video tape recorders, microwaves, etc. It would be obvious to one skilled in the art that processor 198 may be a micro-processor, micro-controller or a general purpose computer.

FIG. 10 is a drawing of a side view of a card 267 inserted in circuit control device 200 showing copper spring contact 206 touching electrical contact 195.

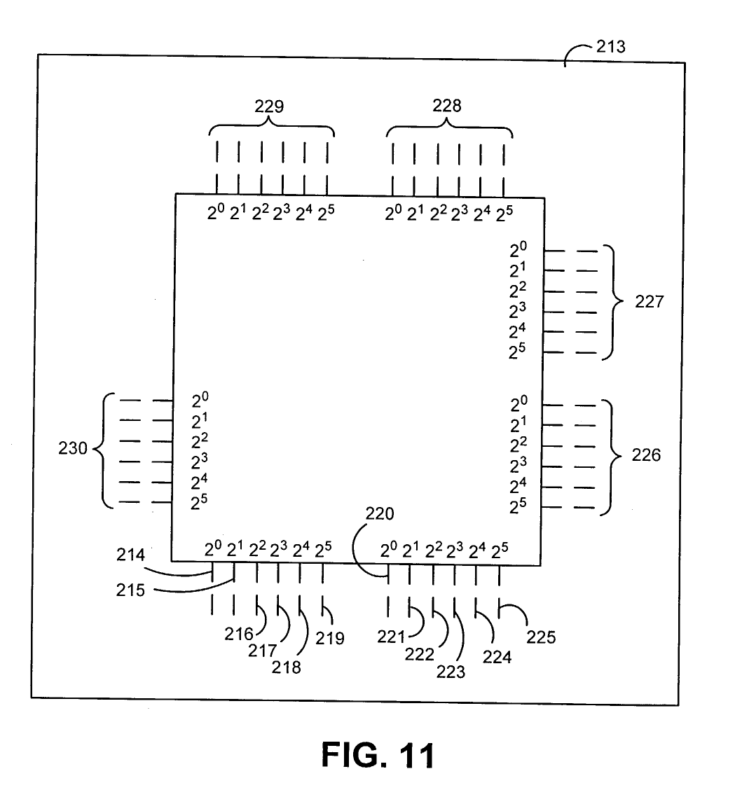

FIG. 11 is a drawing of the back of a business card showing how the back of a business card may permit a user to program their telephone number. Lines 214, 215, 216, 217, 218 and 219 are printed on card 213 by a standard computer printer like the model Desk Jet 880C printer manufactured by Hewlett Packard using a Hewlett Packard 45 black ink cartridge or a Hewlett Packard Laser printer. Lines 214-218 represent the first digit of the phone number of the owner of card 213 in binary. Line 214 would represent 2⁰′, and line 215 would represent 2¹. Line 216 would represent 2², and line 217 would represent 2³. Line 218 would represent 2⁴, and line 219 would represent 2⁵. Thus, if the first digit of the owner of card 213 was a “two”, the open portion of line 215 would be filled in with a pencil or printed by a standard computer printer like the model Desk Jet 880C printer manufactured by Hewlett Packard using a Hewlett Packard 45 black ink cartridge or Hewlett Packard laser printer. The open portion of lines 214, 216 and 217 would not be filed in.

Lines 220-225 represent the second digit of the phone number of the owner of card 213 in binary. Line 220 would represent 2⁰, and line 221 would represent 2¹. Line 222 would represent 2², and line 223 would represent 2³. Line 224 would represent 2⁴ and line 225 would represent 2⁵. Thus, if the second digit of the owner of card 213 was a “three”, the open portion of line 220 and the open portion of line 221 would be filled in with a pencil or printed by a standard computer printer like the model Desk Jet 880C printer manufactured by Hewlett Packard using a Hewlett Packard 45 black ink cartridge or Hewlett Packard laser printer. The open portion of lines 222-225 would not be filed in. The third telephone digit is programmed by completing the desired open spaces of lines 226, and the fourth digit is programmed by completing the desired open spaces of lines 227. The fifth telephone digit is programmed by completing the desired open spaces of lines 228, and the sixth digit is programmed by completing the desired open spaces of lines 229. The seventh telephone digit is programmed by completing the desired open spaces of lines 230.

Card 213 may be placed in a reader (that is similar to circuit control device 200 of FIGS. 9 and 10) that is coupled to a telephone so that the holder of card 213 may place card 213 in the reader and have the phone number programmed into card 213 automatically dialed by the telephone. It would be obvious to one skilled in the art that a facsimile number may also be programmed into card 213. The above reader differs from device 200 in that the perimeter of card 213 is framed by a plurality of contacts similar to contacts 206-211 of FIG. 9 using spring contact mechanism 212. Card 213 may also be used as an input device to personal data assistants.

It would be obvious to one skilled in the art that lines 214-225 may be coupled to lines 52, 53, 54 and 55 of FIG. 2A to program the number transmitted by FFID circuit 10 (FIG. 1). A RFID reader (not shown) may receive the above number and dial telecommunications equipment. Alternatively a RFID reader may be coupled to a personal data assistant to allow the RFID reader to read business card 213 equipped with RFID circuit 10 and store the telephone number.

It would be obvious to one skilled in the art that the phone number recoded above may also be recorded decimally, i.e., one bit for each decimal digit in each place of the phone number.

The above specification describes a new and improved circuit that utilizes printed lines to perform the function of wires so that connections may be switched in the circuit by having an individual connect different printed wires by drawing a penciled or inked lines line between the printed lines. It is realized that the above description may indicate to those skilled in the art additional ways in which the principles of this invention may be used without departing from the spirit. Therefore, it is intended that this invention be limited only by the scope of the appended claims.

What is claimed is:

1. A method for switching connections in a circuit, which comprises the steps of:
A) exposing on a material switching contacts; and
B) altering on the material the switching contacts by applying drawn lines using a pencil, ball point pen or fused toner in a manner that alters the connections to be switched.

2. The method claimed in claim 1, wherein the pencil is a graphite pencil.

3. The method claimed in claim 1, wherein the drawn connection performs the function of a wire.

4. The method claimed in claim 3, further including the step of:
erasing the drawn connection to modify the switching connection.

5. The method claimed in claim 4, further including the step of:
erasing the drawn connection with a pencil eraser.

6. The method claimed in claim 4, further including the step of:
erasing the drawn connection with a ink eraser.

7. The method claimed in claim 1, wherein the altering step further comprises the step of:
marking connections on the material with a ink jet printer to switch the connections into the circuit.

8. The method claimed in claim 7, wherein the marked connections act like wires.

9. The method claimed in claim 8, further including the step of:
erasing the marked connections to modify the connections.

10. The method claimed in claim 1, wherein the material is paper.

11. The method claimed in claim 1, wherein the material is cardboard.

12. The method claimed in claim 1, wherein the material is plastic.

13. The method claimed in claim 1, further including the step of:
inserting the material into a device in a manner that the switching contacts will complete a circuit.

14. The method claimed in claim 13, further including the step of:
inserting the material into a device in a manner that the switching contacts will cause the device to perform some function.

15. The method claimed in claim 13, wherein the device is a electrical or electronic device.

16. The method claimed in claim 13, wherein the device is a microcontroller.

17. The method claimed in claim 1, wherein the altered bits will represent numbers that are used to dial telecommunications equipment.

18. The method claimed in claim 17, wherein the material is in the shape of a card.

19. The method claimed in claim 20, wherein the card is a business card.

20. The method claimed in claim 17, wherein the telecommunications equipment is a telephone.

21. The method claimed in claim 17, wherein the telecommunications equipment is a facsimile machine.

22. The method claimed in claim 17, wherein the telecommunications equipment is a personal data assistant.

23. The method claimed in claim 17, wherein the material is a cellulose type product.

24. The method claimed in claim 17, wherein the material is a plastic.

25. The method claimed in claim 1, wherein the switching connection controls the number generation portion of a RFID circuit.
